(19) United States
(12) Patent Application Publication
(10) Pub. No.: US 2026/0309426 A1
(43) Pub. Date: Oct. 8, 2026

(54) Composite Heat Exchanger

(71) Applicant: HYUNDAI WIA Corporation, Changwon-si (KR)

(72) Inventor: Min Su JEONG, Uiwang-si (KR)

(73) Assignee: HYUNDAI WIA Corporation, Changwon-si (KR)

(21) Appl. No.: 19/637,187

(22) Filed: Apr. 2, 2026

(30) Foreign Application Priority Data
Apr. 7, 2025 (KR) 10-2025-0044606

(51) Int. Cl. F28D 1/04

(52) U.S. Cl. CPC F28D 1/0452

(57) ABSTRACT

Disclosed is a composite heat exchanger. The composite heat exchanger includes a cooling core unit including a front cooling core disposed at a front side and a rear cooling core disposed at a rear side based on an air flow direction, and each of the front cooling core and the rear cooling core includes a plurality of tubes and a plurality of fins. The front cooling core includes a front upper core and a front lower core configured to allow different working fluids to independently flow therethrough, and the rear cooling core includes a rear upper core and a rear lower core configured to allow different working fluids to independently flow therethrough. The front lower core and the rear upper core are fluidly connected to each other to allow a first working fluid to flow therethrough.

### CROSS-REFERENCE TO THE RELATED APPLICATION

The present application claims priority to and the benefit of Korean Patent Application No. 10-2025-0044606, filed on Apr. 7, 2025, in the Korean Intellectual Property Office, the entire disclosure of which is incorporated herein by reference.

### BACKGROUND

### 1. Field

The present disclosure relates to a composite heat exchanger and, more particularly, to a composite heat exchanger capable of improving heat exchange efficiency.

### 2. Description of the Related Art

Generally, a cooling system of an internal combustion engine vehicle is provided with a cooling module including a radiator, a condenser, and a blower fan configured to forcibly blow external air toward the radiator and the condenser. In the cooling module, a radiator through which coolant for cooling an engine flows is disposed, a condenser through which refrigerant for indoor air conditioning flows is provided in front of the radiator, and a blower fan configured to cool the radiator and the condenser using forced air when the vehicle is stopped is provided behind the radiator. Accordingly, external air undergoes primary heat exchange while flowing over the condenser, and the air that has undergone primary heat exchange undergoes subsequent heat exchange while flowing over the radiator.

In the case of an internal combustion engine vehicle, a temperature of coolant at an inlet of a radiator is relatively high (e.g., about 120 ° C), and a temperature of refrigerant at an inlet of a condenser is relatively low. Therefore, heat exchange efficiency is improved when external air (e.g., about 50 ° C) first flows over the condenser. If the radiator is disposed in front of the condenser, the external air may be heated to a temperature higher than the inlet temperature of the condenser while flowing over the high-temperature radiator, and the refrigerant in the condenser may not be sufficiently cooled. Accordingly, heat exchange efficiency is improved when introduced external air (e.g., about 50 ° C) first cools the refrigerant in the less hot condenser and then cools the coolant in the hotter radiator.

However, in the case of an electric vehicle, an inlet temperature of a radiator may be low (e.g., about 65 ° C), which is lower than an inlet temperature of a condenser (e.g., about 100 ° C). Therefore, if a cooling module for an internal combustion engine vehicle is directly applied to an electric vehicle, external air may be heated to a temperature higher than the inlet temperature of the radiator while flowing over the high-temperature condenser. In this case, the external air may not cool refrigerant in the radiator, resulting in deterioration in cooling efficiency of coolant and condensation and heat absorption efficiency of refrigerant.

Therefore, various studies are continuously required to improve efficiency of a cooling system in an electric vehicle.

### SUMMARY

The present disclosure has been made in view of the above-described issues, and an aspect of the present disclosure is to provide a composite heat exchanger having a novel structure capable of improving heat exchange efficiency of a cooling module employed in an electric vehicle.

A composite heat exchanger according to an embodiment of the present disclosure for accomplishing the above aspect includes a cooling core unit including a front cooling core disposed at a front side and a rear cooling core disposed at a rear side based on an air flow direction, each of the front cooling core and the rear cooling core including a plurality of tubes and a plurality of fins, wherein the front cooling core includes a front upper core and a front lower core configured to allow different working fluids to independently flow through the front upper core and the front lower core, the rear cooling core includes a rear upper core and a rear lower core configured to allow different working fluids to independently flow through the rear upper core and the rear lower core, and the front lower core and the rear upper core are fluidly connected to each other to allow a first working fluid to flow through the front lower core and the rear upper core.

The front upper core and the rear lower core may be fluidly connected to each other to allow a second working fluid to flow through the front upper core and the rear lower core.

The composite heat exchanger may further include a pair of headers disposed at respective lateral ends of the cooling core unit, a first tank disposed at each of the lateral ends of the cooling core unit and configured to sealingly cover a portion of each of the lateral ends of the cooling core unit, and a second tank disposed at each of the lateral ends of the cooling core unit and configured to sealingly cover an entire area of each of the lateral ends of the cooling core unit.

The pair of headers may include a first header disposed at one lateral end of the cooling core unit in a width direction and configured to support one lateral end of each of the front cooling core and the rear cooling core and a second header disposed at the other lateral end of the cooling core unit in the width direction and configured to support the other lateral end of each of the front cooling core and the rear cooling core.

The first tank disposed at the other lateral end of the cooling core unit may sealingly cover the other lateral end of each of the front lower core and the rear upper core so as to allow the first working fluid flowing through the other lateral end of each of the front lower core and the rear upper core to flow through the first tank, and the second tank disposed at the other lateral end of the cooling core unit may cover an upper surface of the first tank and may be spaced apart from the upper surface of the first tank so as to allow the second working fluid flowing through the other lateral end of each of the front upper core and the rear lower core to flow through the second tank.

The first tank disposed at the other lateral end of the cooling core unit may include a first lower tank configured to cover the front lower core and a first upper tank configured to cover the rear upper core. The first lower tank and the first upper tank may be spatially separated from each other and may be fluidly connected to each other through a fluid line.

The front upper core and the rear lower core may be disposed such that a lower portion of the front upper core overlaps an upper portion of the rear lower core.

The first tank disposed at the other lateral end of the cooling core unit may include a first lower tank configured to cover the front lower core, a first upper tank configured to cover the rear upper core, and a connection tank configured to interconnect an upper end of the first lower tank and a lower end of the first upper tank so as to provide fluid communication between the first lower tank and the first upper tank. The first lower tank, the first upper tank, and the connection tank may be spatially integrated with each other, and the first lower tank and the first upper tank may be fluidly connected to each other through the connection tank.

The connection tank may cover an end of a tube disposed at a position corresponding to an upper end of the first lower tank and an end of a tube disposed at a position corresponding to a lower end of the first upper tank, and the first working fluid may move between the other lateral end of the front lower core and the other lateral end of the rear upper core through the connection tank.

At the other lateral end of the cooling core unit, the second working fluid may flow through a clearance defined between an upper surface of the first tank and a lower surface of the second tank, and may move between the other lateral end of the front upper core and the other lateral end of the rear lower core through the clearance.

The second tank disposed at one lateral end of the cooling core unit may be provided with first and second pipes for inflow and outflow of the first working fluid and third and fourth pipes for inflow and outflow of the second working fluid.

The first tank disposed at one lateral end of the cooling core unit may include a first blocking wall formed inside the first tank so as to prevent flow of the first working fluid between the front lower core and the rear upper core.

The second tank disposed at one lateral end of the cooling core unit may include a second blocking wall formed inside the second tank so as to prevent flow of the second working fluid between the front upper core and the rear lower core.

The front upper core and the rear lower core may not be in fluid communication with each other, the rear lower core may be configured to allow a second working fluid to flow through the rear lower core, and the front upper core may be configured to allow a third working fluid to flow through the front upper core.

The composite heat exchanger may further include a pair of headers disposed at respective lateral ends of the cooling core unit, a first tank disposed at each of the lateral ends of the cooling core unit and configured to sealingly cover a portion of each of the lateral ends of the cooling core unit, and a second tank disposed at each of the lateral ends of the cooling core unit and configured to sealingly cover an entire area of each of the lateral ends of the cooling core unit.

The first tank disposed at the other lateral end of the cooling core unit may sealingly cover the other lateral end of each of the front lower core and the rear upper core so as to allow the first working fluid flowing through the other lateral end of each of the front lower core and the rear upper core to flow through the first tank, and the second tank disposed at the other lateral end of the cooling core unit may cover an upper surface of the first tank and may have a lower surface in surface contact with the upper surface of the first tank so as to prevent the third working fluid flowing through the other lateral end of the front upper core and the second working fluid flowing through the other lateral end of the rear lower core from meeting each other.

The first tank disposed at the other lateral end of the cooling core unit may include a first lower tank configured to cover the front lower core, a first upper tank configured to cover the rear upper core, and a connection tank configured to interconnect an upper end of the first lower tank and a lower end of the first upper tank so as to provide fluid communication between the first lower tank and the first upper tank. The first lower tank, the first upper tank, and the connection tank may be spatially integrated with each other, and the first lower tank and the first upper tank may be fluidly connected to each other through the connection tank.

The second tank disposed at one lateral end of the cooling core unit may be provided with first and second pipes for inflow and outflow of the first working fluid, a third pipe for inflow or outflow of the second working fluid, and a fourth pipe for inflow or outflow of the third working fluid, and the second tank disposed at the other lateral end of the cooling core unit may be provided with a fifth pipe for outflow or inflow of the second working fluid and a sixth pipe for outflow or inflow of the third working fluid.

The composite heat exchanger may further include a guide duct configured to guide flow of external air introduced into the composite heat exchanger. The guide duct may include an external air inlet portion having a predetermined area and length and an upright guide portion extending from the external air inlet portion, and the front lower core may be disposed at a position corresponding to the external air inlet portion.

The upright guide portion may include an inclined plate extending from the external air inlet portion so as to be inclined upward in an external air flow direction, and the front upper core may be disposed at a position corresponding to the inclined plate.

The front lower core may be configured to allow the first working fluid to flow through the front lower core.

The first working fluid may be refrigerant, and the second working fluid may be coolant.

The first working fluid may be refrigerant, and the second working fluid may be low-temperature coolant.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view of a composite heat exchanger according to a first embodiment of the present disclosure;

FIG. 2 is an exploded perspective view of FIG. 1;

FIG. 3A is a conceptual view showing an arrangement structure of a first tank and a second tank at the other lateral end of a cooling core unit;

FIG. 3B is a conceptual view showing an arrangement structure of the first tank and the second tank at the other lateral end of the cooling core unit;

FIG. 4A is a conceptual view showing a first implementation form of the composite heat exchanger according to the first embodiment of the present disclosure;

FIG. 4B is a conceptual view showing a second implementation form of the composite heat exchanger according to the first embodiment of the present disclosure;

FIG. 5 illustrates a partial perspective view and a cross-sectional view showing a structure in which the first tank and the second tank are mounted at the other lateral end of the cooling core unit in the composite heat exchanger according to the first embodiment of the present disclosure;

FIG. 6 is a perspective view of a composite heat exchanger according to a second embodiment of the present disclosure;

FIG. 7A is a conceptual view showing a first implementation form of the composite heat exchanger according to the second embodiment of the present disclosure;

FIG. 7B is a conceptual view showing a second implementation form of the composite heat exchanger according to the second embodiment of the present disclosure;

FIG. 8 illustrates a partial perspective view and a cross-sectional view showing a structure in which a first tank and a second tank are mounted at the other lateral end of a cooling core unit in the composite heat exchanger according to the second embodiment of the present disclosure; and

FIG. 9 is a conceptual view of a cooling module including a guide duct disposed in front of the composite heat exchanger.

### DETAILED DESCRIPTION OF EXEMPLARY EMBODIMENTS

Hereinafter, exemplary embodiments of the present disclosure will be described in detail with reference to the accompanying drawings. Embodiments of the present disclosure are provided to more fully illustrate the disclosure to a person having ordinary skill in the art, and the following embodiments may be modified in various other forms, and the scope of the disclosure is not limited to the following embodiments. The embodiments are provided to make the disclosure more faithful and complete and to completely convey the idea of the disclosure fully to those skilled in the art.

In the following drawings, the thickness or size of each layer is exaggerated for convenience and clarity of description, and same reference numerals in the drawings refer to the same elements. As used herein, the term “and/or” includes any one of the enumerated items and any combination of one or more thereof. As used herein, the term “connected” refers not only to direct connection between members A and B but also to indirect connection between members A and B with member C interposed therebetween. The terms used in the specification are intended to describe specific embodiments and are not intended to limit the disclosure. As used herein, singular forms may include plural forms, unless the context clearly indicates otherwise. As used herein, the terms “comprise” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups thereof.

While terms such as “first” and “second” are used herein to describe various members, parts, regions, layers, and/or portions, the members, the parts, the regions, the layers, and/or the portions are not to be limited by the terms. The terms are used only to distinguish one member, one part, one region, one layer, or one portion from another member, another part, another region, another layer, or another portion. Thus, a first member, a first part, a first region, a first layer, or a first portion hereinafter described may refer to a second member, a second part, a second region, a second layer, or a second portion without departing from the teachings of the disclosure.

Terms related to space, such as “beneath,” “below,” “lower,” “above,” and “upper,” may be utilized to facilitate understanding of one element or feature shown in the drawings as different from another element or feature. The terms related to space are intended to facilitate understanding of the disclosure in various states of process or use and are not intended to limit the disclosure. For example, if an element or feature in a figure is inverted, an element or feature described as “beneath” or “below” becomes “above” or “upper.” Thus, “beneath” is a concept that encompasses “above” or “below.”

### First Embodiment

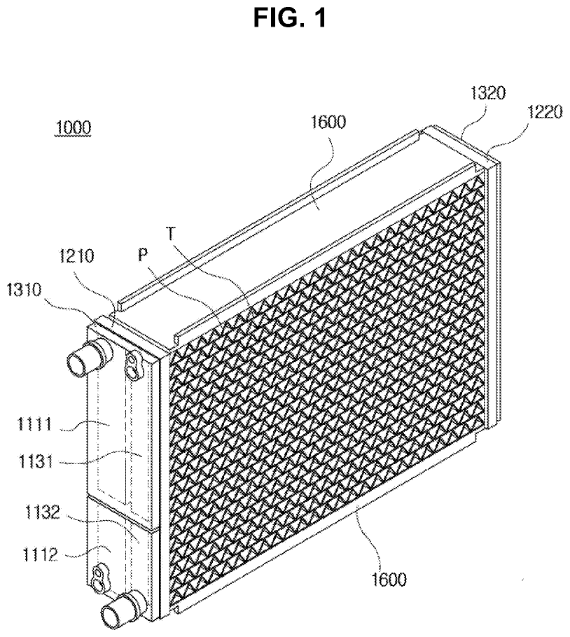

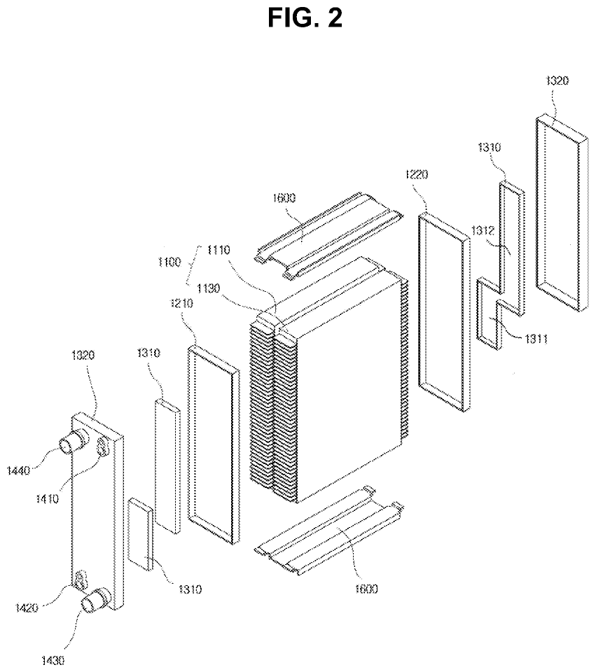

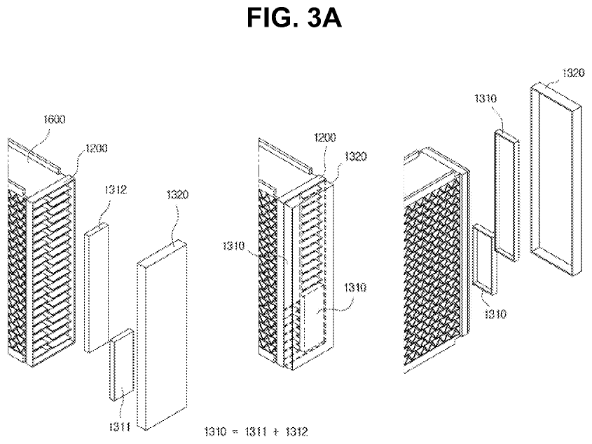

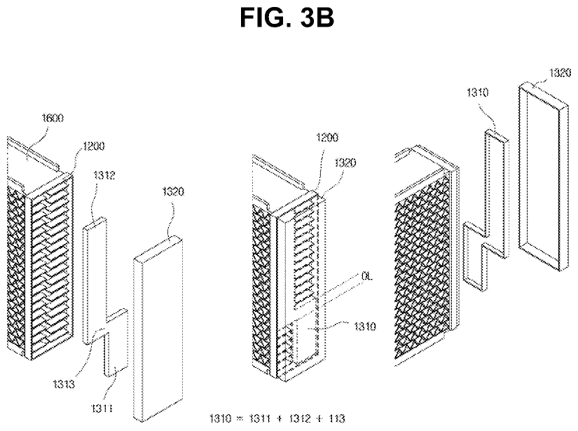

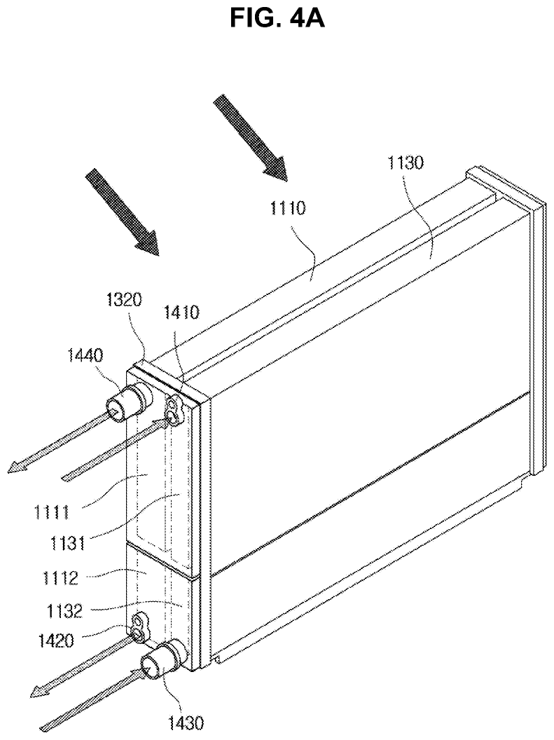

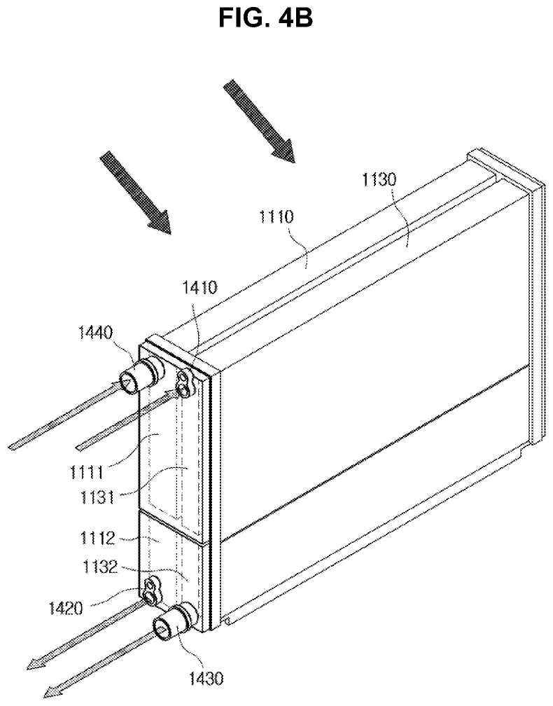

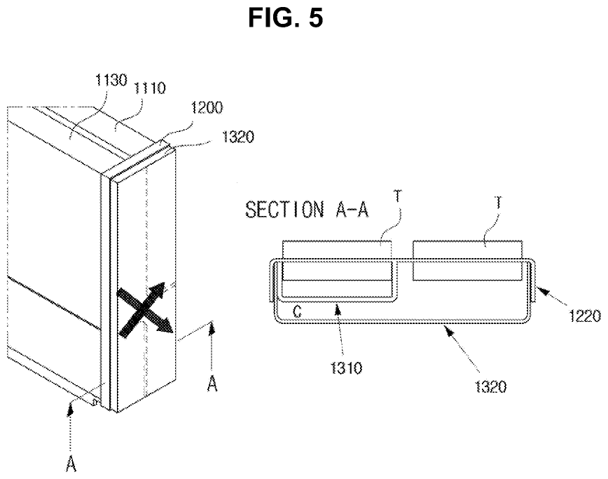

FIG. 1 is a perspective view of a composite heat exchanger according to a first embodiment of the present disclosure, FIG. 2 is an exploded perspective view of FIG. 1, FIGS. 3A and 3B are conceptual views showing an arrangement structure of a first tank and a second tank at the other lateral end of a cooling core unit, FIG. 4A is a conceptual view showing a first implementation form of the composite heat exchanger according to the first embodiment of the present disclosure, FIG. 4B is a conceptual view showing a second implementation form of the composite heat exchanger according to the first embodiment of the present disclosure, and FIG. 5 illustrates a partial perspective view and a cross-sectional view showing a structure in which the first tank and the second tank are mounted at the other lateral end of the cooling core unit in the composite heat exchanger according to the first embodiment of the present disclosure. Hereinafter, the composite heat exchanger 1000 according to the first embodiment of the present disclosure will be described with reference to the drawings.

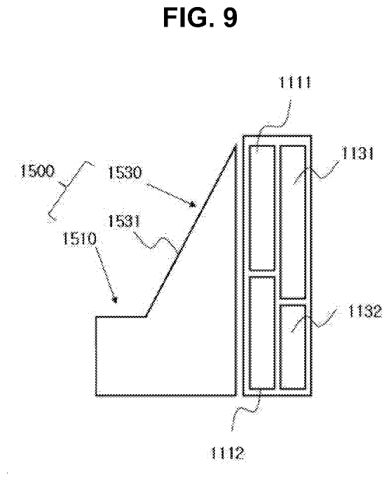

The composite heat exchanger 1000 according to the first embodiment of the present disclosure is a heat exchanger mounted in a cooling module, and includes a cooling core unit 1100 including a front cooling core 1110 and a rear cooling core 1130. As will be described later, the cooling module includes a guide duct 1500 (refer to FIG. 9) provided in front of the composite heat exchanger 1000 to guide flow of external air to the cooling core unit 1100 and a blower fan (not shown) disposed behind the composite heat exchanger 1000. External air is introduced through the guide duct 1500, undergoes heat exchange while flowing over the composite heat exchanger 1000, passes through the blower fan, and is then discharged outside. Hereinafter, based on a flow direction of air in the cooling module, an air inflow side is referred to as a front side, and an air discharge side is referred to as a rear side.

The front cooling core 1110 and the rear cooling core 1130 are disposed at the front side and the rear side, respectively, in the cooling module based on the air flow direction. Accordingly, the external air that has passed through the guide duct 1500 undergoes primary heat exchange while flowing over the front cooling core 1110, and then undergoes secondary heat exchange while flowing over the rear cooling core 1130.

The front cooling core 1110 and the rear cooling core 1130 have the same structure. For example, a plurality of tubes T is disposed to be spaced apart from each other in a predetermined direction, and a fin P is interposed between two adjacent tubes T. FIGS. 1 and 2 exemplarily illustrate a structure in which the plurality of tubes T is disposed in an upward-downward direction. A working fluid flows through each of the plurality of tubes T, and external air flows between the plurality of fins P, thereby achieving heat exchange between the working fluid and the external air. Side plates 1600 may be disposed at respective ends of the cooling core unit 1100 in a height direction to cover both the front cooling core 1110 and the rear cooling core 1130.

Headers 1210 and 1220 are disposed at respective lateral ends of the cooling core unit 1100 including the front cooling core 1110 and the rear cooling core 1130. The first header 1210 is disposed at one lateral end of the cooling core unit 1100 in a width direction to support one lateral end of each of the front cooling core 1110 and the rear cooling core 1130, and the second header 1220 is disposed at the other lateral ends of the cooling core unit 1100 in the width direction to support the other lateral end of each of the front cooling core 1110 and the rear cooling core 1130. As shown in FIG. 2, the first header 1210 may be formed in a frame structure enclosing one lateral end of the cooling core unit 1100, and the second header 1220 may be formed in a frame structure enclosing the other lateral end of the cooling core unit 1100. A first tank 1310 and a second tank 1320 to be described later are coupled to the first header 1210 and the second header 1220.

The tanks 1310 and 1320 are disposed at each of two opposite lateral ends of the cooling core unit 1100. The first tank 1310 is disposed at each of one lateral end and the other lateral end of the cooling core unit 1100 and sealingly covers a portion of each lateral end of the cooling core unit 1100. To this end, as shown in FIG. 2, the first tank 1310 may be formed in a planar shape corresponding to a portion to be covered in each lateral end of the cooling core unit 1100. The second tank 1320 is disposed at each of one lateral end and the other lateral end of the cooling core unit 1100 and sealingly covers an entire area of each lateral end of the cooling core unit 1100. To this end, the second tank 1320 may be formed in a planar shape corresponding to the first header 1210 or the second header 1220.

Description of specific structural features of the first tank 1310 and the second tank 1320 will be given together with the following description of technical features of the cooling core unit 1100.

The front cooling core 1110 of the cooling core unit 1100 may include a front upper core 1111 and a front lower core 1112, through which different working fluids flow independently, and the rear cooling core 1130 of the cooling core unit 1100 may include a rear upper core 1131 and a rear lower core 1132, through which different working fluids flow independently. For reference, the front upper core 1111 and the front lower core 1112 are distinguished because working fluids used therein are different, and structures thereof are not different. Similarly, the rear upper core 1131 and the rear lower core 1132 have the same structure, and working fluids used therein are different.

According to the first embodiment of the present disclosure, the front lower core 1112 and the rear upper core 1131 are fluidly connected to each other so that a first working fluid flows therethrough, and the front upper core 1111 and the rear lower core 1132 are also fluidly connected to each other so that a second working fluid flows therethrough. In an example, the first working fluid may be refrigerant, and the second working fluid may be coolant.

Independent flow of these two different working fluids may be achieved by the structural features of the first tank 1310 and the second tank 1320.

According to the first embodiment of the present disclosure, the second tank 1320 disposed at one lateral end of the cooling core unit 1100 is provided with a first pipe 1410 and a second pipe 1420 for inflow and outflow of the first working fluid and is provided with a third pipe 1430 and a fourth pipe 1440 for inflow and outflow of the second working fluid. The first pipe 1410 and the second pipe 1420 are configured to communicate with an internal space in the first tank 1310. To this end, the first tank 1310 disposed at one lateral end of the cooling core unit 1100 may include through-holes (not shown) through which the first pipe 1410 and the second pipe 1420 pass. The third pipe 1430 and the fourth pipe 1440 are configured to communicate with an internal space in the second tank 1320.

In the first embodiment, at one lateral end of the cooling core unit 1100, the first working fluid flows in and out through the first pipe 1410 and the second pipe 1420, and at the other lateral end of the cooling core unit 1100, the first working fluid flows between the front lower core 1112 and the rear upper core 1131. At one lateral end of the cooling core unit 1100, the second working fluid flows in and out through the third pipe 1430 and the fourth pipe 1440, and at the other lateral end of the cooling core unit 1100, the second working fluid flows between the front upper core 1111 and the rear lower core 1132.

To this end, at one lateral end of the cooling core unit 1100, flow of the working fluid between the front lower core 1112 and the rear upper core 1131 needs to be prevented, and accordingly, the first tank 1310 is configured to independently seal each of the front lower core 1112 and the rear upper core 1131. For example, as shown in FIG. 2, the first tank 1310 is implemented as two independent members configured to seal the front lower core 1112 and the rear upper core 1131, respectively. In detail, the first tank 1310 includes a planar portion having a shape corresponding to one lateral end of the front lower core 1112 and a sidewall portion formed along a periphery of the planar portion, and a space for flow of the working fluid is defined inside the sidewall portion. A sealing member may be interposed between the sidewall portion and the tubes T in order to achieve a fluid-tight seal. If the first tank 1310 is mounted at one lateral end of the front lower core 1112 of the cooling core unit 1100, the sidewall portion of the first tank 1310 encloses one lateral end of the front lower core 1112, thereby blocking ends of the tubes T from the outside. Alternatively, the first tank 1310 disposed at one lateral end of the cooling core unit 1100 may be implemented as a single integrated member, like the first tank 1310 disposed at the other lateral end of the cooling core unit 1100, which will be described later. In this case, a first blocking wall may be mounted inside the first tank 1310 in order to prevent flow of the first working fluid between the front lower core 1112 and the rear upper core 1131.

The first tank 1310 disposed at the other lateral end of the cooling core unit 1100 sealingly covers the other lateral end of each of the front lower core 1112 and the rear upper core 1131 while allowing the first working fluid flowing through the other lateral end of each of the front lower core 1112 and the rear upper core 1131 to flow through the first tank 1310.

To this end, as shown in FIG. 3A, the first tank 1310 disposed at the other lateral end of the cooling core unit 1110 may include a first lower tank 1311 covering the front lower core 1112 and a first upper tank 1312 covering the rear upper core 1131, and the first lower tank 1311 and the first upper tank 1312 may be spatially separated from each other. A separate fluid line (not shown) that fluidly interconnects the first lower tank 1311 and the first upper tank 1312 may be mounted, thereby allowing the first working fluid to flow between the first lower tank 1311 and the first upper tank 1312 through the fluid line.

Alternatively, as shown in FIG. 3B, the first tank 1310 disposed at the other lateral end of the cooling core unit 1110 may be implemented as a single integrated member. For example, the first tank 1310 may include a first lower tank 1311 covering the front lower core 1112, a first upper tank 1312 covering the rear upper core 1131, and a connection tank 1313 interconnecting an upper end of the first lower tank 1311 and a lower end of the first upper tank 1312 to provide fluid communication between the first lower tank 1311 and the first upper tank 1312. The first lower tank 1311, the first upper tank 1312, and the connection tank 1313 are spatially integrated with each other. For reference, if the first tank 1310 having the structure shown in FIG. 3B is employed, an overlap region OL in which at least one tube T positioned at a lower portion of the front upper core 1111 and at least one tube T positioned at an upper portion of the rear lower core 1132 overlap each other is present. The connection tank 1313 covers the overlap region OL, that is, an end of at least one tube T positioned at an upper end of the first lower tank 1311 and an end of at least one tube T positioned at a lower end of the first upper tank 1312. With this structure, the first working fluid flowing into the first lower tank 1311 may flow to the first upper tank 1312 through the connection tank 1313 (flow in the opposite direction is also possible), and the first working fluid may move between the other lateral end of the front lower core 1112 and the other lateral end of the rear upper core 1131 through the connection tank 1313.

The first tank 1310 disposed at the other lateral end of the cooling core unit 1100, which may be implemented in one of the above-described two forms, includes a planar portion having a shape corresponding to a portion to be covered in the cooling core unit 1100 and a sidewall portion formed along a periphery of the planar portion, and a space for flow of the working fluid is defined inside the sidewall portion. If the first tank 1310 is mounted at the other lateral end of the cooling core unit 1100, the sidewall portion of the first tank 1310 encloses ends of some tubes T of the front lower core 1112 and ends of some tubes T of the rear upper core 1131. A sealing member may be interposed between the sidewall portion and the tubes T in order to achieve a fluid-tight seal. Accordingly, the first tank 1310 encloses the front lower core 1112 and the rear upper core 1131, thereby blocking ends of the tubes T from the outside while allowing flow of the fluid between the front lower core 1112 and the rear upper core 1131.

At one lateral end of the cooling core unit 1100, flow of the working fluid between the front upper core 1111 and the rear lower core 1132 needs to be prevented, and accordingly, the second tank 1320 is configured to independently seal each of the front upper core 1111 and the rear lower core 1132. For example, as shown in FIG. 1, the second tank 1320 is implemented as two independent members configured to seal the front upper core 1111 and the rear lower core 1132, respectively. In detail, as shown in FIG. 2, the second tank 1320 may include a tank, which includes a planar portion having a shape corresponding to one lateral end of the front upper core 1111 and one lateral end of the rear upper core 1131 and a sidewall portion formed along a periphery of the planar portion, and a tank, which includes a planar portion having a shape corresponding to one lateral end of the front lower core 1112 and one lateral end of the rear lower core 1132 and a sidewall portion formed along a periphery of the planar portion. A space for flow of the working fluid is defined inside each of the sidewall portions. A sealing member may be interposed between the sidewall portions and the tubes T in order to achieve a fluid-tight seal. If the second tank 1320 configured as described above is mounted at an upper portion and a lower portion of one lateral end of the cooling core unit, one lateral end of the front upper core 1111 and one lateral end of the rear lower core 1132 are sealingly blocked. Alternatively, the second tank 1320 disposed at one lateral end of the cooling core unit 1100 may be implemented as a single integrated member, like the first tank 1310, and a second blocking wall may be mounted inside the second tank 1320 in order to prevent flow of the second working fluid between the front upper core 1111 and the rear lower core 1132.

The second tank 1320 disposed at the other lateral end of the cooling core unit 1100 sealingly covers an entire area of the other lateral end of the cooling core unit 1100 so as to allow the second working fluid flowing through the other lateral end of each of the front upper core 1111 and the rear lower core 1132 to flow through the second tank 1320. To this end, the second tank 1320 disposed at the other lateral end of the cooling core unit 1100 includes a planar portion having a shape corresponding to an entire area of the other lateral end of the cooling core unit 1100 and a sidewall portion formed along a periphery of the planar portion, and a space for flow of the working fluid is defined inside the sidewall portion. If the second tank 1320 is mounted at the other lateral end of the cooling core unit 1100, the second tank 1320 encloses an entirety of ends of the tubes T exposed at the other lateral end of the cooling core unit 1100. A sealing member may be interposed between the sidewall portion and the tubes T in order to achieve a fluid-tight seal.

As shown in FIG. 5, the second tank 1320 disposed at the other lateral end of the cooling core unit 1100 is designed to cover an upper surface of the first tank 1310 and to be spaced apart from the upper surface of the first tank 1310. In more detail, referring to section A-A in FIG. 5, the first tank 1310 fluid-tightly encloses the tubes T at the other lateral end of each of the front lower core 1112 and the rear upper core 1131, and accordingly, the first working fluid does not flow outside the first tank 1310. In this state, if the second tank is mounted to enclose an entire surface of the other lateral end of the cooling core unit 1100, the second tank 1320 is disposed above the first tank 1310 so as to be spaced apart from the upper surface of the first tank 1310, and accordingly, a clearance C is defined between the first tank 1310 and the second tank 1320. Because the tubes T at the other lateral end of each of the front lower core 1112 and the rear upper core 1131 are fluid-tightly sealed by the first tank 1310, the other lateral end of the rear lower core 1132 and the other lateral end of the front upper core 1111, excluding the other lateral end of the front lower core 1112 and the other lateral end of the rear upper core 1131, are in fluid communication with each other through the clearance C. With this structure, the second working fluid flows through the tubes T at both the other lateral end of the rear lower core 1132 and the other lateral end of the front upper core 1111.

Accordingly, at the other lateral end of the cooling core unit 1100, the second working fluid flows through the clearance C between the upper surface of the first tank 1310 and the lower surface of the second tank 1320. Through this clearance C, the second working fluid flowing through the other lateral end of the front upper core 1111 and the other lateral end of the rear lower core 1132 may move between the other lateral end of the front upper core 1111 and the other lateral end of the rear lower core 1132 within the second tank 1320.

Hereinafter, flow of the first working fluid and the second working fluid in the composite heat exchanger 1000 according to the first embodiment of the present disclosure will be described.

FIG. 4A is a conceptual view showing a first implementation form of the composite heat exchanger 1000 according to the first embodiment of the present disclosure.

The second tank 1320 disposed at one lateral end of the cooling core unit 1100 is provided with a first pipe 1410 and a second pipe 1420 for inflow and outflow of the first working fluid and is provided with a third pipe 1430 and a fourth pipe 1440 for inflow and outflow of the second working fluid. In the first implementation form, the first pipe 1410 is a first working fluid inlet pipe, the second pipe 1420 is a first working fluid outlet pipe, the third pipe 1430 is a second working fluid inlet pipe, and the fourth pipe 1440 is a second working fluid outlet pipe.

The first working fluid is introduced into an upper end of the first tank 1310 through the first pipe 1410. The introduced first working fluid is introduced into one lateral end of the rear upper core 1131, flows from one lateral end to the other lateral end of the rear upper core 1131 through the tubes T of the rear upper core 1131, and then reaches an internal space in the first tank 1310 disposed at the other lateral end of the rear upper core 1131. The first working fluid flows from an upper region of the first tank 1310 corresponding to the rear upper core 1131, that is, the first upper tank 1312, to a lower region of the first tank 1310 corresponding to the front lower core 1112, that is, the first lower tank 1311 (refer to FIGS. 3A and 5). Thereafter, the first working fluid flows from the other lateral end to one lateral end of the front lower core 1112 through the tubes T of the front lower core 1112, reaches an internal space in the first tank 1310 disposed at one lateral end of the front lower core 1112, and is then discharged through the second pipe 1420.

The second working fluid is introduced into a lower end of the second tank 1320 disposed at one lateral end of the cooling core unit 1100 through the third pipe 1430. The introduced second working fluid is introduced into one lateral end of the rear lower core 1132. In this process, the second tank 1320 disposed at one lateral end of the rear lower core 1132 is filled with the second working fluid. Thereafter, the second working fluid flows from one lateral end to the other lateral end of the rear lower core 1132 through the tubes T of the rear lower tube 1132, and then reaches an internal space in the second tank 1320 disposed at the other lateral end of the rear lower core 1132. The second working fluid flows from a lower region of the second tank 1320 corresponding to the rear lower core 1132 to an upper region of the second tank 1320 corresponding to the front upper core 1111 (refer to FIG. 5). In detail, the second working fluid moves to the upper region of the second tank 1320 through the clearance C between the upper surface of the first tank 1310 and the lower surface of the second tank 1320. Thereafter, the second working fluid flows from the other lateral end to one lateral end of the front upper core 1111 through the tubes T of the front upper core 1111, reaches an internal space in the second tank 1320 disposed at one lateral end of the front upper core 1111, and is then discharged through the fourth pipe 1440. In an example, the first working fluid may be refrigerant, and the second working fluid may be coolant.

According to the above-described flow of the working fluids, a temperature of the refrigerant flowing through the front lower core is lower than a temperature of the coolant flowing through the rear lower core disposed behind the front lower core, and a temperature of the coolant flowing through the front upper core is lower than a temperature of the refrigerant flowing through the rear upper core disposed behind the front upper core.

In detail, high-temperature coolant (e.g., about 65 °C) flows through the rear lower core 1132, and low-temperature coolant, which has a reduced temperature through heat exchange in the rear lower core 1132, flows through the front upper core 1111. High-temperature refrigerant (e.g., about 100 °C) flows through the rear upper core 1131, and low-temperature refrigerant (e.g., about 60 °C), which has a reduced temperature through heat exchange in the rear upper core 1131, flows through the front lower core 1112. In this state, if external air (e.g., about 50 °C) is introduced, the introduced external air sequentially flows, at the lower portion of the composite heat exchanger 1000, over the front lower core 1112 through which the low-temperature refrigerant flows and the rear lower core 1132 through which the high-temperature coolant flows, and sequentially flows, at the upper portion of the composite heat exchanger 1000, over the front upper core 1111 through which the low-temperature coolant flows and the rear upper core 1131 through which the high-temperature refrigerant flows. Accordingly, the working fluids having a relatively low temperature first exchange heat with the external air at both the lower portion and the upper portion of the composite heat exchanger 1000, thereby preventing deterioration in heat exchange efficiency.

FIG. 4B is a conceptual view showing a second implementation form of the composite heat exchanger 1000 according to the first embodiment of the present disclosure.

In the second implementation form, the first pipe 1410 is a first working fluid inlet pipe, and the second pipe 1420 is a first working fluid outlet pipe. Flow of the first working fluid is identical to that in the first implementation form. In an example, the first working fluid may be refrigerant.

The third pipe 1430 and the fourth pipe 1440 are pipes for inflow and outflow of the second working fluid. The fourth pipe 1440 is a second working fluid inlet pipe, and the third pipe 1430 is a second working fluid outlet pipe. The second working fluid is introduced into an upper end of the second tank 1320 disposed at one lateral end of the cooling core unit 1100 through the fourth pipe 1440. The introduced second working fluid is introduced into one lateral end of the front upper core 1111. In this process, the second tank 1320 disposed at one lateral end of the front upper core 1111 is filled with the second working fluid. Thereafter, the second working fluid flows from one lateral end to the other lateral end of the front upper core 1111 through the tubes T of the front upper core 1111, and then reaches an internal space in the second tank 1320 disposed at the other lateral end of the front upper core 1111. The second working fluid flows from an upper region of the second tank 1320 corresponding to the front upper core 1111 to a lower region of the second tank 1320 corresponding to the rear lower core 1132 (refer to FIG. 5). In detail, the second working fluid moves to the lower region of the second tank 1320 through the clearance C between the upper surface of the first tank 1310 and the lower surface of the second tank 1320. Thereafter, the second working fluid flows from the other lateral end to one lateral end of the rear lower core 1132 through the tubes T of the rear lower core 1132, reaches an internal space in the second tank 1320 disposed at one lateral end of the rear lower core 1132, and is then discharged through the third pipe 1430. In an example, the first working fluid may be refrigerant, and the second working fluid may be coolant.

According to the above-described flow of the working fluids, a temperature of the refrigerant flowing through the front lower core is lower than a temperature of the coolant flowing through the rear lower core disposed behind the front lower core, and a temperature of the coolant flowing through the front upper core is lower than a temperature of the refrigerant flowing through the rear upper core disposed behind the front upper core.

In detail, high-temperature refrigerant (e.g., about 100 °C) flows through the rear upper core 1131, and low-temperature refrigerant (e.g., about 60 °C), which has a reduced temperature through heat exchange in the rear upper core 1131, flows through the front lower core 1112. High-temperature coolant (e.g., about 65 °C) flows through the front upper core 1111, and low-temperature coolant, which has a reduced temperature through heat exchange in the front upper core 1111, flows through the rear lower core 1132. In this state, if external air (e.g., about 50 °C) is introduced, the introduced external air sequentially flows, at the lower portion of the composite heat exchanger 1000, over the front lower core 1112 through which the low-temperature refrigerant flows and the rear lower core 1132 through which the low-temperature coolant flows, and sequentially flows, at the upper portion of the composite heat exchanger 1000, over the front upper core 1111 through which the high-temperature coolant flows and the rear upper core 1131 through which the high-temperature refrigerant flows.

The high-temperature coolant in the front upper core 1111 may have a temperature lower than a temperature of the high-temperature refrigerant in the rear upper core 1131, and the low-temperature refrigerant in the front lower core 1112 may have a temperature lower than or similar to a temperature of the low-temperature coolant in the rear lower core 1132. Accordingly, the working fluids having a relatively low temperature first exchange heat with the external air at both the lower portion and the upper portion of the composite heat exchanger 1000, thereby preventing deterioration in heat exchange efficiency.

### Second Embodiment

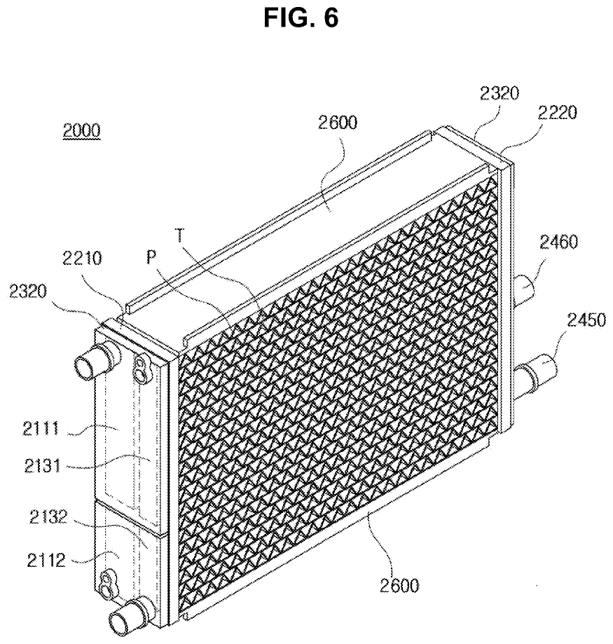

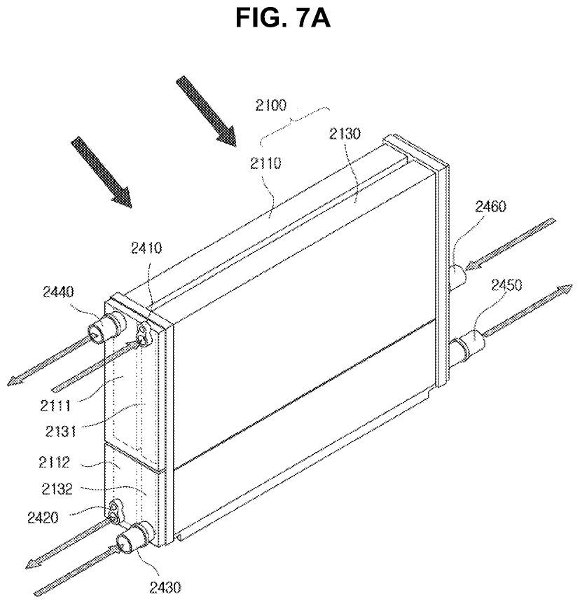

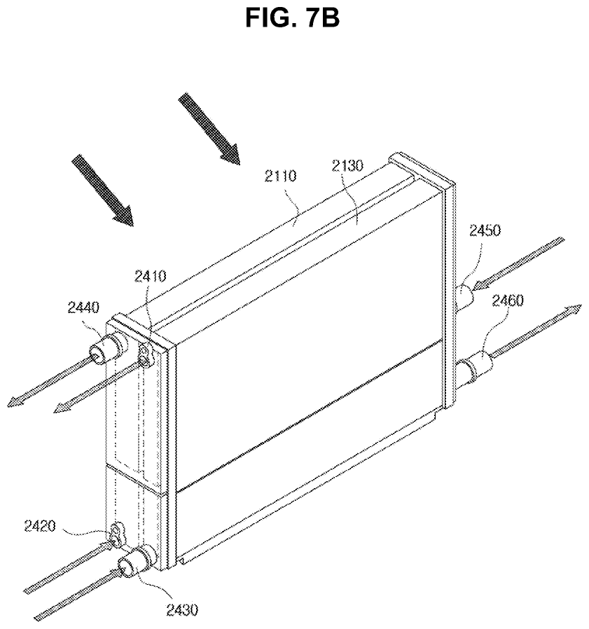

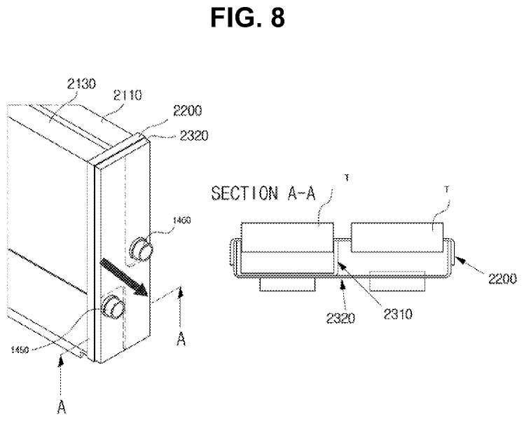

FIG. 6 is a perspective view of a composite heat exchanger according to a second embodiment of the present disclosure, FIG. 7A is a conceptual view showing a first implementation form of the composite heat exchanger according to the second embodiment of the present disclosure, FIG. 7B is a conceptual view showing a second implementation form of the composite heat exchanger according to the second embodiment of the present disclosure, and FIG. 8 illustrates a partial perspective view and a cross-sectional view showing a structure in which a first tank 2310 and a second tank 2320 are mounted at the other lateral end of a cooling core unit 2100 in the composite heat exchanger according to the second embodiment of the present disclosure. Hereinafter, the composite heat exchanger 2000 according to the second embodiment of the present disclosure will be described with reference to the drawings.

The composite heat exchanger 2000 according to the second embodiment of the present disclosure includes a cooling core unit 2100 including a front cooling core 2110 and a rear cooling core 2130, first and second headers 2210 and 2220 disposed at respective lateral ends of the cooling core unit 2100, a first tank 2310 disposed at each of one lateral end and the other lateral end of the cooling core unit 2100 and configured to sealingly cover a portion of each lateral end of the cooling core unit 2100, and a second tank 2320 disposed at each of one lateral end and the other lateral end of the cooling core unit 2100 and configured to sealingly cover an entire area of each lateral end of the cooling core unit 2100. The front cooling core 2110 includes a front upper core 2111 and a front lower core 2112, through which different working fluids flow independently, and the rear cooling core 2130 includes a rear upper core 2131 and a rear lower core 2132, through which different working fluids flow independently. This configuration is the same as that of the first embodiment. With regard to the same configuration as that of the first embodiment, reference may be made to the description of the first embodiment.

In the second embodiment, the front lower core 2112 and the rear upper core 2131 are fluidly connected to each other so that a first working fluid flows therethrough. This configuration is the same as that of the first embodiment. In detail, at one lateral end of the cooling core unit 2100, each of the front lower core 2112 and the rear upper core 2131 is independently sealed by the first tank 2310, and at the other lateral end of the cooling core unit 2100, the front lower core 2112 and the rear upper core 2131 are in fluid communication with each other through the first tank 2310. To this end, like the first embodiment described above, the first tank 2310 disposed at the other lateral end of the cooling core unit 2100 may be provided with a separate fluid line (not shown) that fluidly interconnects the first lower tank and the first upper tank, so that the first working fluid flows between the first lower tank and the first upper tank through the fluid line. Alternatively, the first tank 2310 disposed at the other lateral end of the cooling core unit 2100 may include a first lower tank covering the front lower core 2112, a first upper tank covering the rear upper core 2131, and a connection tank interconnecting an upper end of the first lower tank and a lower end of the first upper tank to provide fluid communication between the first lower tank and the first upper tank. The first lower tank, the first upper tank, and the connection tank may be spatially integrated with each other. In this structure, the first lower tank and the first upper tank are fluidly connected to each other through the connection tank. With regard to this configuration, reference may be made to the description of the first embodiment.

As described above, the first embodiment is configured such that the front upper core 1111 and the rear lower core 1132 are in fluid communication with each other so that one working fluid flows therethrough. In contrast, the second embodiment is configured such that the front upper core 2111 and the rear lower core 2132 are not in fluid communication with each other so that different working fluids respectively flow therethrough. In detail, in the second embodiment, only a second working fluid may flow through the rear lower core 2132, and only a third working fluid may flow through the front upper core 2111.

In order to implement independent flow of different working fluids through the rear lower core 2132 and the front upper core 2111, the second embodiment differs from the first embodiment in a coupling structure of the first tank 2310 and the second tank 2320 at the other lateral end of the cooling core unit 2100.

In detail, the first tank 2310 disposed at the other lateral end of the cooling core unit 2100 sealingly covers the other lateral end of each of the front lower core 2112 and the rear upper core 2131 while allowing the first working fluid flowing through the other lateral end of each of the front lower core 2112 and the rear upper core 2131 to flow through the first tank 2310. To this end, similar to the first embodiment, the first tank 2310 may include a planar portion having a shape corresponding to the other lateral end of the front lower core 2112 and a sidewall portion formed along a periphery of the planar portion. If the first tank 2310 is mounted at the other lateral end of the cooling core unit 2100, the sidewall portion of the first tank 2310 encloses ends of some tubes T of the front lower core 2112 and ends of some tubes T of the rear upper core 2131. Accordingly, the first tank 2310 encloses the front lower core 2112 and the rear upper core 2131, thereby blocking ends of the tubes T from the outside while allowing flow of the fluid between the front lower core 2112 and the rear upper core 2131.

As shown in FIG. 8, the second tank 2320 provided at the other lateral end of the cooling core unit 2100 is disposed to cover an upper surface of the first tank 2310. Furthermore, a lower surface of the second tank 2320 is in surface contact with the upper surface of the first tank 2310. Because the second tank 2320 is designed to be in surface contact with the upper surface of the first tank 2310, rather than being spaced apart therefrom, the clearance C included in the first embodiment is not present in the second embodiment. Accordingly, flow of the fluid between the front upper core 2111 and the rear lower core 2132 is prevented, and the third working fluid flowing through the other lateral end of the front upper core 2111 and the second working fluid flowing through the other lateral end of the rear lower core 2132 do not meet each other.

In the second embodiment, the second tank 2320 disposed at one lateral end of the cooling core unit 2100 is provided with a first pipe 2410, a second pipe 2420, a third pipe 2430, and a fourth pipe 2440 for inflow and outflow of the working fluid. This configuration is the same as that of the first embodiment. However, the second embodiment differs from the first embodiment in that a fifth pipe 2450 and a sixth pipe 2460 for inflow and outflow of the working fluid are additionally provided at the second tank 2320 disposed at the other lateral end of the cooling core unit 2100.

The first pipe 2410 and the second pipe 2420 are pipes for inflow and outflow of the first working fluid. The first pipe 2410 and the second pipe 2420 are formed to communicate with an internal space in the first tank 2310. To this end, the first tank 2310 disposed at one lateral end of the cooling core unit 2100 may include through-holes (not shown) through which the first pipe 2410 and the second pipe 2420 pass. This configuration is the same as that of the first embodiment.

The third pipe 2430 and the fifth pipe 2450 are disposed for inflow and outflow of the second working fluid. The third pipe 2430 is mounted to the second tank 2320 disposed at one lateral end of the cooling core unit 2100 and is formed to communicate with the rear lower core 2132 through an internal space in the second tank 2320, and the fifth pipe 2450 is mounted to the second tank 2320 disposed at the other lateral end of the cooling core unit 2100 and is formed to communicate with the rear lower core 2132 through an internal space in the second tank 2320. Accordingly, a flow path is defined through the third pipe 2430, the rear lower core 2132, and the fifth pipe 2450, and the second working fluid flows in and out through this flow path.

The fourth pipe 2440 and the sixth pipe 2460 are disposed for inflow and outflow of the third working fluid. The fourth pipe 2440 is mounted to the second tank 2320 disposed at one lateral end of the cooling core unit 2100 and is formed to communicate with the front upper core 2111 through the internal space in the second tank 2320, and the sixth pipe 2460 is mounted to the second tank 2320 disposed at the other lateral end of the cooling core unit 2100 and is formed to communicate with the front upper core 2111 through the internal space in the second tank 2320. Accordingly, a flow path is defined through the fourth pipe 2440, the front upper core 2111, and the sixth pipe 2460, and the third working fluid flows in and out through this flow path.

Hereinafter, flow of the first working fluid, the second working fluid, and the third working fluid in the composite heat exchanger 2000 according to the second embodiment of the present disclosure will be described.

FIG. 7A is a conceptual view showing a first implementation form of the composite heat exchanger 2000 according to the second embodiment of the present disclosure.

In the first implementation form, the first pipe 2410 is a first working fluid inlet pipe, and the second pipe 2420 is a first working fluid outlet pipe. The first working fluid is introduced into an upper end of the first tank 2310 through the first pipe 2410. The introduced first working fluid is introduced into one lateral end of the rear upper core 2131, flows from one lateral end to the other lateral end of the rear upper core 2131 through the tubes T of the rear upper core 2131, and then reaches an internal space in the first tank 2310 disposed at the other lateral end of the rear upper core 2131. The first working fluid flows from an upper region (the first upper tank) of the first tank 2310 corresponding to the rear upper core 2131 to a lower region (the first lower tank) of the first tank 2310 corresponding to the front lower core 2112 (refer to FIG. 8). Thereafter, the first working fluid flows from the other lateral end to one lateral end of the front lower core 2112 through the tubes T of the front lower core 2112, reaches an internal space in the first tank 2310 disposed at one lateral end of the front lower core 2112, and is then discharged through the second pipe 2420. In an example, the first working fluid may be refrigerant.

The third pipe 2430 and the fifth pipe 2450 are pipes for inflow and outflow of the second working fluid. The third pipe 2430 is a second working fluid inlet pipe, and the fifth pipe 2450 is a second working fluid outlet pipe. The second working fluid is introduced into a lower end of the second tank 2320 through the third pipe 2430. The introduced second working fluid is introduced into one lateral end of the rear lower core 2132. In this process, the second tank 2320 is filled with the second working fluid. Thereafter, the second working fluid flows from one lateral end to the other lateral end of the rear lower core 2132 through the tubes T of the rear lower core 2132, and then reaches an internal space in the second tank 2320 disposed at the other lateral end of the rear lower core 2132. Because the second tank 2320 disposed at the other lateral end of the rear lower core 2132 prevents flow of the fluid from the rear lower core 2132 to the front upper core 2111, the second working fluid is directly discharged through the fifth pipe 2450. In an example, the second working fluid may be high-temperature coolant.

The fourth pipe 2440 and the sixth pipe 2460 are pipes for inflow and outflow of the third working fluid. The sixth pipe 2460 is a third working fluid inlet pipe, and the fourth pipe 2440 is a third working fluid outlet pipe. The third working fluid is introduced into a lower end of the second tank 2320 through the sixth pipe 2460. The introduced third working fluid is introduced into the other lateral end of the front upper core 2111. In this process, the second tank 2320 is filled with the third working fluid. Thereafter, the third working fluid flows from the other lateral end to one lateral end of the front upper core 2111 through the tubes T of the front upper core 2111, and then reaches an internal space in the second tank 2320 disposed at one lateral end of the front upper core 2111. Then, the third working fluid is directly discharged through the fourth pipe 2440. In an example, the third working fluid may be low-temperature coolant.

According to the above-described flow of the working fluids, a temperature of the refrigerant flowing through the front lower core is lower than a temperature of the coolant (high-temperature coolant) flowing through the rear lower core disposed behind the front lower core, and a temperature of the coolant (low-temperature coolant) flowing through the front upper core is lower than a temperature of the refrigerant flowing through the rear upper core disposed behind the front upper core.

In detail, high-temperature refrigerant (e.g., about 100 °C) flows through the rear upper core 2131, and low-temperature refrigerant (e.g., about 60 °C), which has a reduced temperature through heat exchange in the rear upper core 2131, flows through the front lower core 2112. High-temperature coolant flows through the rear lower core 2132, and low-temperature coolant flows through the front upper core 2111. In this state, if external air (e.g., about 50 °C) is introduced, the introduced external air sequentially flows, at the lower portion of the composite heat exchanger 2000, over the front lower core 2112 through which the low-temperature refrigerant flows and the rear lower core 2132 through which the high-temperature coolant flows, and sequentially flows, at the upper portion of the composite heat exchanger 2000, over the front upper core 2111 through which the low-temperature coolant flows and the rear upper core 2131 through which the high-temperature refrigerant flows. Accordingly, the working fluids having a relatively low temperature first exchange heat with the external air at both the lower portion and the upper portion of the composite heat exchanger 2000, thereby preventing deterioration in heat exchange efficiency.

FIG. 7B is a conceptual view showing a second implementation form of the composite heat exchanger 2000 according to the second embodiment of the present disclosure.

In the second implementation form, the first pipe 2410 is a first working fluid inlet pipe, and the second pipe 2420 is a first working fluid outlet pipe. Flow of the first working fluid is identical to that in the first implementation form. In an example, the first working fluid may be refrigerant.

The third pipe 2430 and the fifth pipe 2450 are pipes for inflow and outflow of the second working fluid. The third pipe 2430 is a second working fluid inlet pipe, and the fifth pipe 2450 is a second working fluid outlet pipe. Flow of the second working fluid is identical to that in the first implementation form. In an example, the second working fluid may be low-temperature coolant.

The fourth pipe 2440 and the sixth pipe 2460 are pipes for inflow and outflow of the third working fluid. The sixth pipe 2460 is a third working fluid inlet pipe, and the fourth pipe 2440 is a third working fluid outlet pipe. Flow of the third working fluid is identical to that in the first implementation form. In an example, the third working fluid may be high-temperature coolant.

According to the above-described flow of the working fluids, a temperature of the refrigerant flowing through the front lower core is lower than a temperature of the coolant (low-temperature coolant) flowing through the rear lower core disposed behind the front lower core, and a temperature of the coolant (high-temperature coolant) flowing through the front upper core is lower than a temperature of the refrigerant flowing through the rear upper core disposed behind the front upper core.

In detail, high-temperature refrigerant (e.g., about 100 °C) flows through the rear upper core 2131, and low-temperature refrigerant (e.g., about 60 °C), which has a reduced temperature through heat exchange in the rear upper core 2131, flows through the front lower core 2112. Low-temperature coolant flows through the rear lower core 2132, and high-temperature coolant flows through the front upper core 2111. In this state, if external air (e.g., about 50 °C) is introduced, the introduced external air sequentially flows, at the lower portion of the composite heat exchanger 2000, over the front lower core 2112 through which the low-temperature refrigerant flows and the rear lower core 2132 through which the low-temperature coolant flows, and sequentially flows, at the upper portion of the composite heat exchanger 2000, over the front upper core 2111 through which the high-temperature coolant flows and the rear upper core 2131 through which the high-temperature refrigerant flows. The high-temperature coolant in the front upper core 2111 may have a temperature lower than a temperature of the high-temperature refrigerant in the rear upper core 2131, and the low-temperature refrigerant in the front lower core 2112 may have a temperature lower than or similar to a temperature of the low-temperature coolant in the rear lower core 2132. Accordingly, the working fluids having a relatively low temperature first exchange heat with the external air at both the lower portion and the upper portion of the composite heat exchanger 2000, thereby preventing deterioration in heat exchange efficiency.

The composite heat exchanger 1000 according to the first embodiment or the composite heat exchanger 2000 according to the second embodiment of the present disclosure is a component constituting a cooling module. The cooling module further includes a guide duct 1500 configured to guide flow of external air in front of the composite heat exchanger 1000 or 2000 to the cooling core unit 1100 or 2100 and a blower fan disposed behind the composite heat exchanger 1000 or 2000.

Referring to FIG. 9, the guide duct 1500 includes an external air inlet portion 1510 and an upright guide portion 1530. The external air inlet portion 1510 includes an air inlet having a predetermined area, and the upright guide portion 1530 includes an inclined plate 1531 extending backward from the external air inlet portion 1510 so as to be inclined upward in an external air flow direction. The upright guide portion 1530 is configured such that a cross-sectional area thereof gradually increases in the external air flow direction due to upward inclination of the inclined plate 1531. Accordingly, if external air is introduced through the air inlet of the guide duct 1500, the external air may be gradually diffused and distributed over the entire surface of the composite heat exchanger 1000 or 2000.

According to the embodiment of the present disclosure, the front lower core 1112 or 2112 of the front cooling core 1110 or 2110 is disposed at a position corresponding to the air inlet, and the front upper core 1111 or 2111 of the front cooling core 1110 or 2110 is disposed at a position corresponding to the inclined plate 1531. With this configuration, external air that has passed through the air inlet directly impinges on the front lower core 1112 or 2112, whereas the front upper core 1111 or 2111 is exposed to diffused external air and thus receives less direct air impingement. The embodiment of the present disclosure is configured such that the first working fluid flows through the front lower core 1112 or 2112 and the second working fluid flows through the front upper core 1111 or 2111. In this case, the first working fluid is refrigerant and the second working fluid is coolant. In general, a radiator is known to be more vulnerable to external impact than a condenser. Therefore, if foreign matter impinges on the radiator, the radiator may be damaged or break. In the present disclosure, refrigerant as the first working fluid flows through the front lower core 1112 or 2112, on which foreign matter impinges, so that the front lower core 1112 or 2112 performs a function of a condenser. As described above, the composite heat exchanger according to the embodiment of the present disclosure is designed such that different working fluids flow in opposite directions through the front upper core, the front lower core, the rear upper core, and the rear lower core and such that the front lower core serves as a condenser through which refrigerant flows, thereby preventing or minimizing damage to or breakage of the composite heat exchanger caused by impingement of foreign matter and improving durability of the composite heat exchanger.

As is apparent from the above description, the embodiment of the present disclosure is configured such that working fluids having a relatively low temperature first exchange heat with external air at both a lower portion and an upper portion of a composite heat exchanger, thereby improving heat exchange efficiency.

Furthermore, the composite heat exchanger according to the embodiment of the present disclosure is designed such that refrigerant as a working fluid flows through a front lower core, thereby preventing or minimizing damage to or breakage of a cooling core unit caused by impingement of external air thereon.

The above is only one embodiment for implementing the composite heat exchanger according to the disclosure, the disclosure is not limited to the above embodiment, and it is to be understood by those skilled in the art that various modifications can be made without departing from the gist of the disclosure as claimed in the following claims.

What is claimed is:

1. A composite heat exchanger comprising a cooling core unit comprising a front cooling core disposed at a front side and a rear cooling core disposed at a rear side based on an air flow direction, each of the front cooling core and the rear cooling core comprising a plurality of tubes and a plurality of fins,
wherein the front cooling core comprises a front upper core and a front lower core configured to allow different working fluids to independently flow through the front upper core and the front lower core,
wherein the rear cooling core comprises a rear upper core and a rear lower core configured to allow different working fluids to independently flow through the rear upper core and the rear lower core, and
wherein the front lower core and the rear upper core are fluidly connected to each other to allow a first working fluid to flow through the front lower core and the rear upper core.

2. The composite heat exchanger as claimed in claim 1, wherein the front upper core and the rear lower core are fluidly connected to each other to allow a second working fluid to flow through the front upper core and the rear lower core.

3. The composite heat exchanger as claimed in claim 2, further comprising:
a pair of headers disposed at respective lateral ends of the cooling core unit;
a first tank disposed at each of the lateral ends of the cooling core unit, the first tank being configured to sealingly cover a portion of each of the lateral ends of the cooling core unit; and
a second tank disposed at each of the lateral ends of the cooling core unit, the second tank being configured to sealingly cover an entire area of each of the lateral ends of the cooling core unit.

4. The composite heat exchanger as claimed in claim 3, wherein the pair of headers comprises:
a first header disposed at one lateral end of the cooling core unit in a width direction, the first header being configured to support one lateral end of each of the front cooling core and the rear cooling core; and
a second header disposed at the other lateral end of the cooling core unit in the width direction, the second header being configured to support the other lateral end of each of the front cooling core and the rear cooling core.

5. The composite heat exchanger as claimed in claim 4, wherein the first tank disposed at the other lateral end of the cooling core unit sealingly covers the other lateral end of each of the front lower core and the rear upper core so as to allow the first working fluid flowing through the other lateral end of each of the front lower core and the rear upper core to flow through the first tank, and
wherein the second tank disposed at the other lateral end of the cooling core unit covers an upper surface of the first tank and is spaced apart from the upper surface of the first tank so as to allow the second working fluid flowing through the other lateral end of each of the front upper core and the rear lower core to flow through the second tank.

6. The composite heat exchanger as claimed in claim 5, wherein the first tank disposed at the other lateral end of the cooling core unit comprises:
a first lower tank configured to cover the front lower core; and
a first upper tank configured to cover the rear upper core,
wherein the first lower tank and the first upper tank are spatially separated from each other and are fluidly connected to each other through a fluid line, and
wherein the front upper core and the rear lower core are disposed such that a lower portion of the front upper core overlaps an upper portion of the rear lower core.

7. The composite heat exchanger as claimed in claim 5, wherein the first tank disposed at the other lateral end of the cooling core unit comprises:
a first lower tank configured to cover the front lower core;
a first upper tank configured to cover the rear upper core; and
a connection tank configured to interconnect an upper end of the first lower tank and a lower end of the first upper tank so as to provide fluid communication between the first lower tank and the first upper tank,
wherein the first lower tank, the first upper tank, and the connection tank are spatially integrated with each other, and
wherein the first lower tank and the first upper tank are fluidly connected to each other through the connection tank.

8. The composite heat exchanger as claimed in claim 7, wherein the connection tank covers an end of a tube disposed at a position corresponding to an upper end of the first lower tank and an end of a tube disposed at a position corresponding to a lower end of the first upper tank, and
wherein the first working fluid moves between the other lateral end of the front lower core and the other lateral end of the rear upper core through the connection tank.

9. The composite heat exchanger as claimed in claim 5, wherein, at the other lateral end of the cooling core unit, the second working fluid flows through a clearance defined between an upper surface of the first tank and a lower surface of the second tank, and moves between the other lateral end of the front upper core and the other lateral end of the rear lower core through the clearance.

10. The composite heat exchanger as claimed in claim 2, wherein the second tank disposed at one lateral end of the cooling core unit is provided with first and second pipes for inflow and outflow of the first working fluid and third and fourth pipes for inflow and outflow of the second working fluid.

11. The composite heat exchanger as claimed in claim 2, wherein the first tank disposed at one lateral end of the cooling core unit comprises a first blocking wall formed inside the first tank so as to prevent flow of the first working fluid between the front lower core and the rear upper core.

12. The composite heat exchanger as claimed in claim 2, wherein the second tank disposed at one lateral end of the cooling core unit comprises a second blocking wall formed inside the second tank so as to prevent flow of the second working fluid between the front upper core and the rear lower core.

13. The composite heat exchanger as claimed in claim 1, wherein the front upper core and the rear lower core are not in fluid communication with each other,
wherein the rear lower core is configured to allow a second working fluid to flow through the rear lower core, and
wherein the front upper core is configured to allow a third working fluid to flow through the front upper core.

14. The composite heat exchanger as claimed in claim 13, further comprising:
a pair of headers disposed at respective lateral ends of the cooling core unit;
a first tank disposed at each of the lateral ends of the cooling core unit, the first tank being configured to sealingly cover a portion of each of the lateral ends of the cooling core unit; and
a second tank disposed at each of the lateral ends of the cooling core unit, the second tank being configured to sealingly cover an entire area of each of the lateral ends of the cooling core unit.

15. The composite heat exchanger as claimed in claim 14, wherein the first tank disposed at the other lateral end of the cooling core unit sealingly covers the other lateral end of each of the front lower core and the rear upper core so as to allow the first working fluid flowing through the other lateral end of each of the front lower core and the rear upper core to flow through the first tank, and
wherein the second tank disposed at the other lateral end of the cooling core unit covers an upper surface of the first tank and has a lower surface in surface contact with the upper surface of the first tank so as to prevent the third working fluid flowing through the other lateral end of the front upper core and the second working fluid flowing through the other lateral end of the rear lower core from meeting each other.

16. The composite heat exchanger as claimed in claim 15, wherein the first tank disposed at the other lateral end of the cooling core unit comprises:
a first lower tank configured to cover the front lower core;
a first upper tank configured to cover the rear upper core; and
a connection tank configured to interconnect an upper end of the first lower tank and a lower end of the first upper tank so as to provide fluid communication between the first lower tank and the first upper tank,
wherein the first lower tank, the first upper tank, and the connection tank are spatially integrated with each other,
wherein the first lower tank and the first upper tank are fluidly connected to each other through the connection tank,
wherein the second tank disposed at one lateral end of the cooling core unit is provided with first and second pipes for inflow and outflow of the first working fluid, a third pipe for inflow or outflow of the second working fluid, and a fourth pipe for inflow or outflow of the third working fluid, and
wherein the second tank disposed at the other lateral end of the cooling core unit is provided with a fifth pipe for outflow or inflow of the second working fluid and a sixth pipe for outflow or inflow of the third working fluid.

17. The composite heat exchanger as claimed in claim 1, further comprising a guide duct configured to guide flow of external air introduced into the composite heat exchanger,
wherein the guide duct comprises:
an external air inlet portion having a predetermined area and length; and
an upright guide portion extending from the external air inlet portion,
wherein the front lower core is disposed at a position corresponding to the external air inlet portion.

18. The composite heat exchanger as claimed in claim 17, wherein the upright guide portion comprises an inclined plate extending from the external air inlet portion so as to be inclined upward in an external air flow direction,
wherein the front upper core is disposed at a position corresponding to the inclined plate, and
wherein the front lower core is configured to allow the first working fluid to flow through the front lower core.

19. The composite heat exchanger as claimed in claim 2, wherein the first working fluid is refrigerant and the second working fluid is coolant.

20. The composite heat exchanger as claimed in claim 13, wherein the first working fluid is refrigerant and the second working fluid is low-temperature coolant.
